(19) United States
(12) Patent Application Publication
(10) Pub. No.: US 2018/0060327 A1
(43) Pub. Date: Mar. 1, 2018

(54) CALCULATING A FAILURE INTENSITY VALUE FOR A GROUP OF SEARCH SESSIONS

(71) Applicant: Red Hat, Inc., Raleigh, NC (US)

(72) Inventors: James E. Scarborough, Apex, NC (US); John P. Sherman, Apex, NC (US); Spenser E. Shumaker, Rolesville, NC (US); Michael D. Graham, Raleigh, NC (US)

(21) Appl. No.: 15/252,806

(22) Filed: Aug. 31, 2016

(51) Int. Cl. G06F 17/30

(52) U.S. Cl. CPC G06F 17/3053; G06F 17/30598

(57) ABSTRACT

Calculating a failure intensity value for a group of search sessions is provided. In one example, a method for calculating a failure intensity value for a group of search sessions is provided. The method includes obtaining, by a computing device comprising a processor device, the group of search sessions, where each search session of the group of search sessions includes user input that identifies a search query. The method further includes classifying each search session of the group of search sessions into one or more result categories, where each result category is indicative of an outcome of a search session. The method additionally includes calculating the failure intensity value for the group of search sessions based on a combination of weighted values of the group of search sessions, where the weighted values are based on the one or more result categories of the group of search sessions.

### TECHNICAL FIELD

The examples relate generally to search sessions and, in particular, to mechanisms for calculating a failure intensity value for a group of search sessions.

### BACKGROUND

When a customer requires assistance with a product, the customer might search a web site or database for solutions. The quality of the search is important for providing timely and informative solutions to the customer's queries.

### SUMMARY

The examples include mechanisms for calculating a failure intensity value for a group of search sessions. Among other advantages, calculating the failure intensity value for the group of search sessions according to examples disclosed herein may be useful for automatically detecting which areas of the search process are in need of improvement and which aspects might have the largest impact on overall search quality.

In one example, a computing device is provided. The computing device includes a memory and a processor device coupled to the memory. The processor device is to obtain a group of search sessions, where each search session includes user input that identifies a search query. The processor device is further to classify each search session into one or more result categories, where each result category is indicative of an outcome of a search session. The processor device is also to calculate a failure intensity value for the group of search sessions based on a combination of weighted values of the group of search sessions, where the weighted values are based on the one or more result categories of the group of search sessions.

In another example, a method for calculating a failure intensity value for a group of search sessions is provided. The method includes obtaining, by a computing device comprising a processor device, the group of search sessions, where each search session of the group of search sessions includes user input that identifies a search query. The method further includes classifying each search session of the group of search sessions into one or more result categories, where each result category is indicative of an outcome of a search session. The method additionally includes calculating the failure intensity value for the group of search sessions based on a combination of weighted values of the group of search sessions, where the weighted values are based on the one or more result categories of the group of search sessions.

In another example, a computer program product for calculating a failure intensity value for a group of search sessions is provided. The computer program product is stored on a non-transitory computer-readable storage medium, and includes instructions to cause a processor device to obtain the group of search sessions, where each search session of the group of search sessions includes user input that identifies a search query. The instructions are further to cause the processor device to classify each search session of the group of search sessions into one or more result categories, where each result category is indicative of an outcome of a search session. The instructions are also to cause the processor device to calculate the failure intensity value for the group of search sessions based on a combination of weighted values of the group of search sessions, where the weighted values are based on the one or more result categories of the group of search sessions.

Individuals will appreciate the scope of the disclosure and realize additional aspects thereof after reading the following detailed description of the examples in association with the accompanying drawing figures.

### BRIEF DESCRIPTION OF THE DRAWINGS

The accompanying drawing figures incorporated in and forming a part of this specification illustrate several aspects of the disclosure and, together with the description, serve to explain the principles of the disclosure.

FIG. 1 is a block diagram of a system in which examples may be practiced;

FIG. 2 is a flowchart of a method for calculating a failure intensity value for a group of search sessions by the system of FIG. 1 according to one example;

FIG. 3 is a block diagram of a system including additional elements in which examples may be practiced;

FIG. 4 is a flowchart illustrating additional operations for calculating a failure intensity value by the system of FIG. 3 according to one example; and

FIG. 5 is a block diagram of a computing device suitable for implementing examples according to one example.

### DETAILED DESCRIPTION

The examples set forth below represent the information to enable individuals to practice the examples and illustrate the best mode of practicing the examples. Upon reading the following description in light of the accompanying drawing figures, individuals will understand the concepts of the disclosure and will recognize applications of these concepts not particularly addressed herein. It should be understood that these concepts and applications fall within the scope of the disclosure and the accompanying claims.

Any flowcharts discussed herein are necessarily discussed in some sequence for purposes of illustration, but unless otherwise explicitly indicated, the examples are not limited to any particular sequence of steps. As used herein and in the claims, the articles “a” and “an” in reference to an element refers to “one or more” of the element unless otherwise explicitly specified.

When a customer requires assistance with a product, the customer might enter a search query into a search process for a web site or database offered by the manufacturer of the product in order to find solutions in the search results. The quality of the search results provided by the search process is relatively important for providing timely and informative solutions to the customer's queries.

If the customer cannot find an acceptable solution in the search results provided by the search process, the manufacturer of the product may lose goodwill with the customer, and the manufacturer may have to expend additional resources to provide a solution. In some examples, costs can be measured in terms of the cost to resolve a support case or the loss of goodwill which might result in non-renewal of the customer's contract. In order to minimize these costs, some examples herein provide a single metric that quantifies a search quality provided by the search process across multiple ways of accessing the search process, and some examples provide actionable metrics indicating a relative importance of focusing improvement efforts on any of several areas of the search process.

The examples process a plurality of search sessions, each of which comprises one or more search queries of a user. The examples calculate a failure intensity value which quantifies a search quality of the plurality of search sessions. The failure intensity value is based, at least in part, on one or more result categories of each search session. Example result categories include a conversion result, where the user selects one of the search results as an answer to the user's query, and an abandonment result, where a user gives up looking for the answer to the user's query.

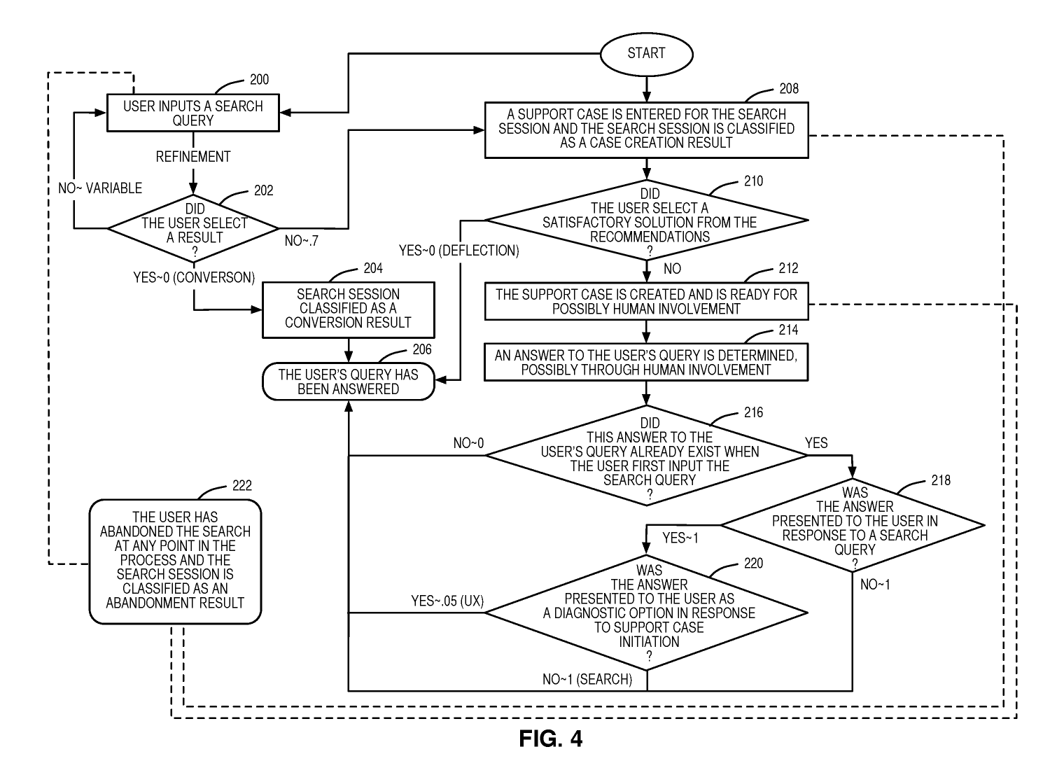

In some examples, this single metric for search quality is represented by a failure intensity value that is calculated based on the cost of failure at every transition in a customer's traversal from one state to another state during a search session. A search session includes one or more related search queries and additional actions that might be taken while evaluating the search results. An example flow chart representing possible paths from entering a search query to exiting (successfully or otherwise) is provided in FIG. 4 and discussed below in more detail.

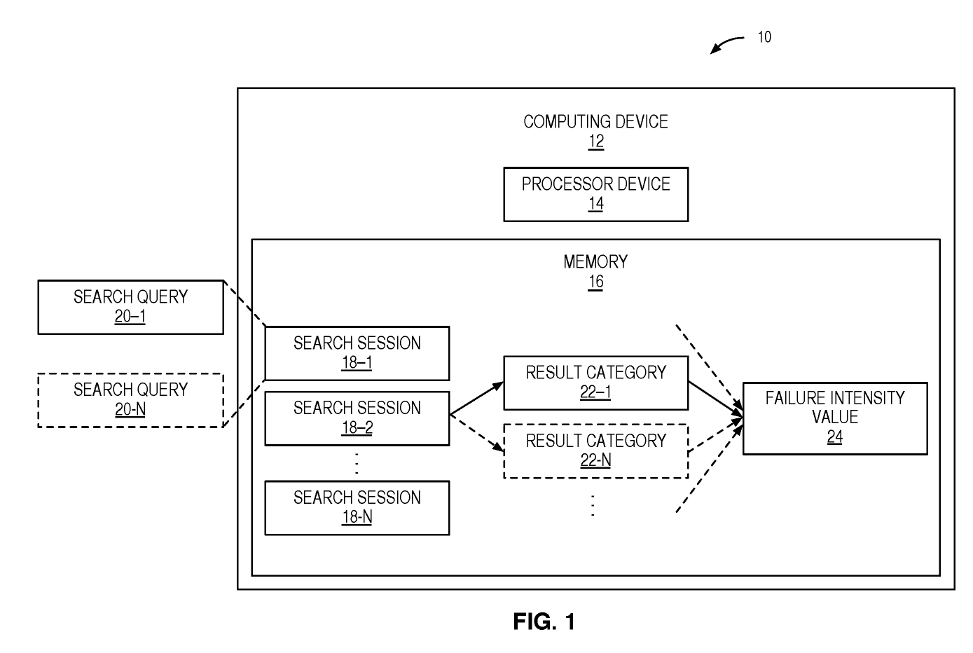

In this regard, FIG. 1 is a block diagram of a system 10 in which examples may be practiced. The system 10 includes a computing device 12 which includes a processor device 14 and a memory 16. The memory 16 may comprise a random access memory (RAM) such as a dynamic random access memory (DRAM), as a non-limiting example. The memory 16 may also comprise any combination of types of storage devices, such as, by way of non-limiting example, a hard disk drive (HDD), a solid state drive (SSD), or the like, and may comprise and/or provide a computer-readable medium. The memory 16 may store executable code containing computer-executable instructions for performing operations described herein.

A group of search sessions 18-1 through 18-N (referred to herein in singular as a search session 18 or in plural as search sessions 18) is stored in the memory 16. Each search session 18 comprises one or more search queries 20-1 through 20-N (referred to herein in singular as a search query 20 or in plural as search queries 20). Each search query 20 comprises one or more search terms entered by a user. Search queries 20 entered by the user may be processed by a search process, and may be stored in access logs for subsequent analysis. The access logs may be accessed, and various search queries 20 may be identified as being a part of a single search session 18. Thus, a search session 18 may comprise the search queries 20 of a single user.

For some or all of the search sessions 18, various measurements can be made, such as the number of times different search queries 20 were entered, the number of search terms entered in the search queries 20, and the number of documents on the user selects. In some examples, each search session 18 is processed and classified into one or more result categories 22-1 through 22-N (referred to herein in singular as a result category 22 or in plural as result categories 22).

The result categories 22 for the various search sessions 18 are used by the processor device 14 to calculate a failure intensity value 24 as is discussed in more detail below. Note that although FIG. 1 only illustrates the search queries 20 included in search session 18-1 and the result categories 22 for the search session 18-2, it is to be understood that the other search sessions 18 also include one or more search queries 20 and are classified into one or more result categories 22. While the example of FIG. 1 shows each of these processes being performed by the processor device 14 of the computing device 12, one or more of these processes may be performed elsewhere and provided to the computing device 12.

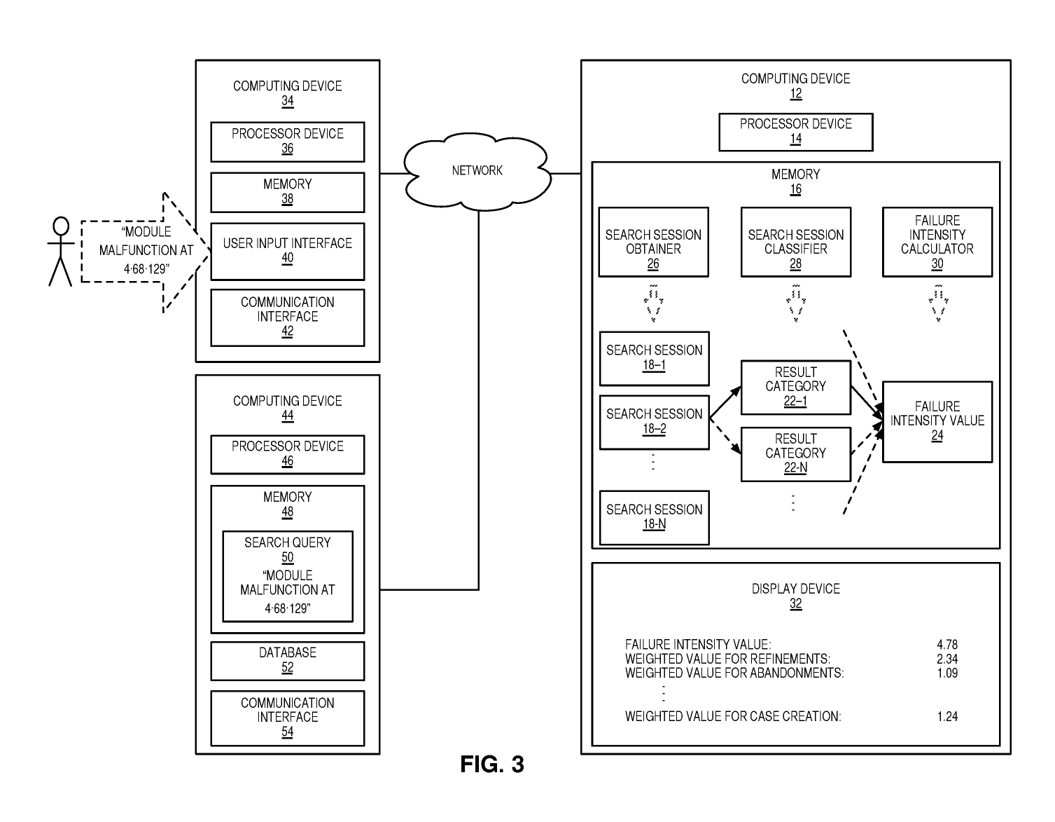

In some examples, this failure intensity value 24 provides a single metric for search quality provided by the search process across multiple ways of accessing the search process. This value may be tracked over time to determine if the quality of the search results provided is improving. Also, in some examples, an indication of one or more weighted values of the search sessions 18 on which the failure intensity value 24 is based might be used. This provides actionable metrics indicating the relative importance of focusing improvement efforts on any of several areas of the search process. Examples of the result categories 22 defined therein and how the failure intensity value 24 is calculated using the result categories 22 are described in greater detail below with respect to FIGS. 3 and 4.

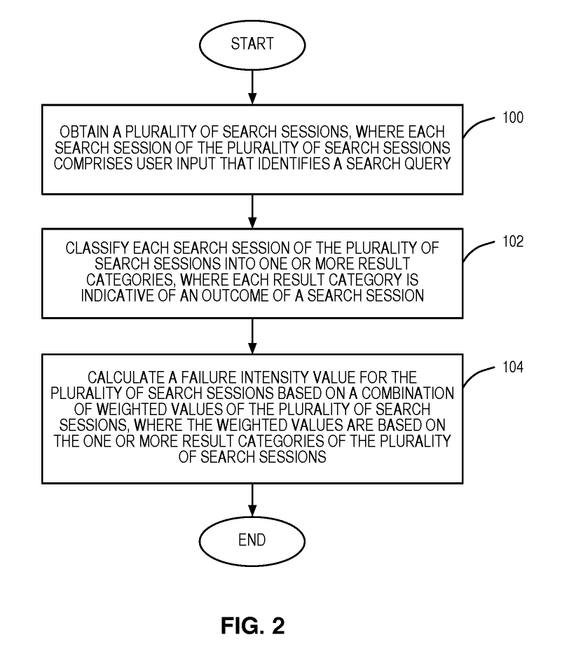

To illustrate operations for calculating a failure intensity value 24 for a group of search sessions 18 by the system 10 of FIG. 1 according to one example, FIG. 2 is provided. For the sake of clarity, elements of FIG. 1 are referenced in describing FIG. 2. To begin operations as illustrated in FIG. 2, the processor device 14 obtains a group of search sessions 18, where each search session 18 comprises user input that identifies a search query 20 (block 100). According to some examples, operations of block 100 for obtaining the search sessions 18 may be responsive to another part of the system 10 initiating the process. For instance, another computing device might initiate this process on a set schedule such as once a week. Further, operations of block 100 might obtain the search sessions 18 from various locations depending on implementation. For example, the search sessions 18 may be included in various log files maintained by a computing device that performs the search queries 20 associated with the search sessions 18.

The processor device 14 then classifies each search session 18 into the one or more result categories 22, where each result category 22 is indicative of an outcome of one of the search sessions 18 (block 102). The processor device 14 calculates the failure intensity value 24 for the group of search sessions 18 based on a combination of the weighted values of the search sessions 18, where the weighted values are based on the one or more result categories 22 of the group of search sessions 18 (block 104). In some examples, the weights are chosen specifically to count failures in comparison to a worst-case failure. The worst-case failure may be that the user does not find an acceptable solution and/or that a support case is opened when the solution already existed. In some examples, the processor device 14 may also present, on a display device, an indication of the failure intensity value 24 for the search sessions 18, as discussed in more detail below. Also, in some examples, the processor device 14 might present, on the display device, an indication of one or more of the weighted values of the search sessions 18 on which the failure intensity value 24 is based, as discussed in more detail below.

FIG. 3 is a block diagram of the system 10 of FIG. 1 and includes additional elements in which examples may be practiced. Elements of FIG. 3 that are common to FIG. 1 are numbered as in FIG. 1. As seen in FIG. 3, the memory 16 of the computing device 12 further includes a search session obtainer 26 which in some examples performs the operations of block 100 of FIG. 2 for obtaining the group of search sessions 18, where each search session 18 includes user input that identifies the search query 20.

FIG. 3 also illustrates that the memory 16 of the computing device 12 further includes a search session classifier 28 and a failure intensity calculator 30. In some examples, the search session classifier 28 performs the operations of block 102 of FIG. 2 for classifying each search session 18 into one or more result categories 22, where each result category 22 is indicative of an outcome of a search session 18. Likewise, the failure intensity calculator 30 performs the operations of block 104 of FIG. 2 for calculating the failure intensity value 24 for the group of search sessions 18 based on a combination of weighted values of the search sessions 18, where the weighted values are based on the one or more result categories 22 of the group of search sessions 18.

Also shown in FIG. 3 is a display device 32 included in the computing device 12. In this example, the display device 32 might be used to present, by the processor device 14, an indication of the failure intensity value 24 for the search sessions 18, as discussed above. An example is shown in FIG. 3 where the failure intensity value 24 is indicated to be 4.78. Also in this example, the processor device 14 has presented on the display device 32 an indication of one or more of the weighted values of the search sessions 18 on which the failure intensity value 24 is based, as discussed above. Specifically, the weighted value for refinements is indicated to be 2.34; the weighted value for abandonments is indicated to be 1.09; and the weighted value for case creation is indicated to be 1.24. Note that although FIG. 3 illustrates specific weighted values, these are merely examples. Different values might be presented in different ways depending on implementation. Also, in some examples, the processor device 14 may create a report which might be displayed elsewhere. This report creation may be in addition to or instead of the display device 32 above.

FIG. 3 also illustrates two additional computing devices which may be involved in the system 10. The computing device 34 includes a processor device 36 and a memory 38. This computing device 34 includes at least a user input interface 40 which can accept an input from a user. As shown, the user input interface 40 of computing device 34 is receiving an input from a user of “Module Malfunction at 4:68:129.” In this example, this user input represents a potential search query that has been entered. In this example, the computing device 34 uses a communication interface 42 to communicate this search query to a separate computing device 44 which will actually perform the search process and return search results.

The computing device 44 includes a processor device 46 and a memory 48. The memory 48 includes the user input as a search query 50 which may later be obtained by computing device 12 as a search query 20. This computing device 44 includes a database 52 that will actually be queried for results that match the search query 50. A communication interface 54 might be used to receive the user input from the computing device 34 associated with a user and also to relay any results retrieved to the computing device 34.

In some examples, the communication interface 54 is also used to provide various search queries to the search session obtainer 26 of the computing device 12. As shown in FIG. 3, the communication between the computing device 12, the computing device 34, and the computing device 44 is through a network. Note that in some examples the various communication links might be on separate networks (e.g., the internet, an internal network, a virtual private network, etc.) or might be through other communication mechanisms (e.g., by direct connection, through a virtual machine interface, etc.).

To illustrate the possibilities for an example search query 20 and for some types of result categories 22 and how they may be used to calculate the failure intensity value 24, FIG. 4 is provided. As seen in FIG. 4, a user first inputs a search query (block 200). This may correspond to the user entering a search query via the user input interface 40 of computing device 34 shown in FIG. 3. After the search results are provided to the user in an appropriate way, it is determined if the user selected a result (block 202). If the user selected a result and did not subsequently search, the search session 18 that this query is included in is classified as a conversion result (block 204). In this example, a conversion result is one of the result categories 22. When calculating the failure intensity value 24, a weighted value of zero is used for the conversion result. In this case, the user's query has been answered and the process can conclude (block 206).

If the user did not select a result, two different paths might be chosen. In one path, the user returns to block 200 and inputs another search query 20. This is considered a refinement result where the search session 18 includes more than one search query 20. In this example, a refinement result is one of the result categories 22. When calculating the failure intensity value 24, a weighted value of a nondecreasing function of a number of search queries 20 included in the search session 18 for the refinement result is used. That is, the more refinements, the higher the weighted value goes. The weighted value is a nondecreasing function because it might be capped at some maximum value. That is, in some examples, a number of refinements beyond the maximum value will still result in the same weighted value. In other examples, the nondecreasing function is a linear function, or a higher order polynomial. In some examples, the nondecreasing function is an exponential function of the number of refinements such as e In(2)/3+R−1 where R is the number of refinements. Of course, after refinement, the process returns to block 202 to determine if the user selected a result based on the refined query.

If the user did not select a result and inputs another search query 20, the user might access a system to enter a support case for the search session (block 208). In this case, the search session 18 is classified as a case creation result. In this example, a case creation result is one of the result categories 22. When calculating the failure intensity value 24, a weighted value of a case creation penalty value is used. This case creation penalty value is tunable depending on implementation and the desired level of failure to assign to this outcome. As shown in the example of FIG. 4, the case creation penalty value is 0.7.

After the creation of a support case has been started, some examples attempt to automatically provide diagnostic solutions to the user. In this case, it is determined if the user selected a satisfactory solution from the recommendations (block 210). If such a diagnostic is found, this is considered a deflection result. In this example, a deflection result is one of the result categories 22. When calculating the failure intensity value 24, a weighted value of zero for the refinement result is used. In this case, the user's query has been answered and the process can conclude at block 206.

If no diagnostics are found by the user, the support case is created and is ready for possibly human involvement (block 212). At this stage, an answer to the user's query is determined, possibly through human involvement (block 214). Next it is determined if this answer to the user's query already existed when the user first input the search query (block 216). If the answer did not already exist, this was a new problem and/or a new solution. Therefore, the search session 18 is classified as a resolved result where a solution found for the support case created for the search session 18 is new. In this example, the resolved result is a result category 22 and a weighted value of zero is used. In this case, the user's query has been answered and the process can conclude at block 206.

On the other hand, if this answer did already exist, the search session 18 is classified as a previously resolved result where a solution found for the support case created for the search session 18 is not new. In this case, some weighted value should be used to indicate this failure as part of the failure intensity value 24. In this example, additional evaluations are performed to determine how a weighted value should be assigned in the calculation of the failure intensity value 24. For instance, in the example of FIG. 4, it is determined if this answer was presented to the user in response to a search query 20 of the search session 18 (block 218). If the answer was not presented to the user, a weighted value of one is used and it is included as part of a failure in the search process itself.

If the answer was presented to the user, but the user did not select the result, this is also a failure. It is optionally additionally determined if this answer was also presented to the user as a diagnostic option in response to the support case initiation after block 208 (block 220). If this answer was not presented to the user as a diagnostic recommendation, a weighted value of one is used and it is included as part of a failure in the search process itself. However, if it was also presented to the user as a diagnostic, but the user still did not select the result, then a weighted value of 0.5 is used and it is included as part of a failure in the user experience (UX).

Another problem that may occur during the search process is an abandonment. In this case, the user has abandoned the search process at any point in the process and the search session 18 is classified as an abandonment result (block 222). In this example, the abandonment result is a result category 22 and a weighted value of an abandonment penalty value is used in the calculation of the failure intensity value. Since it is unknown why the user abandoned the search process, the abandonment penalty value is tunable and in this example is 0.5.

The flow chart in FIG. 4 may be traversed many times to create many different search sessions 18. Each of the search sessions 18 includes one or more search queries 20 and will be classified into one or more result categories 22. The processor device 14 will calculate the failure intensity value 24 as a combination of weighted values associated with the result categories 22 assigned to the group of search sessions 18. As discussed above, in some examples access logs are obtained and a search session 18 is associated with each user. In some examples, a search session 18 is created by observing consecutive events by the same user, and successive search queries 20 within a minute (or any other determined amount of time) of each other are counted as refinements and included in the same search session 18. Visiting a document and not entering another search query 20 for a minute (or any other determined amount of time) counts as a conversion and the user's query has been answered. The user choosing to create a support case within a fixed number of clicks or search queries 20 counts as that transition, and all the other entries to the search page count as abandonments.

In some examples, the failure intensity value 24 is calculated by summing the number of each of the different result categories 22, dividing by the number of search sessions 18 being analyzed, and multiplying each by the weighted value associated with each result category 22. In some examples, a separate failure intensity value 24 can be created for result categories 22 related to the search process and refining the search queries 20 and another failure intensity value 24 for result categories 22 related to support case creation. Also, as discussed above, the weighted values associated with various result categories 22 may also be presented as is shown on display device 32 in FIG. 3.

Note that while specific result categories 22 were presented herein, these are merely examples. An implementation may include some or all of these result categories 22 or may contain additional result categories 22 not disclosed herein. Also, while specific weighted values are discussed in relation to the result categories 22, these are merely examples. An implementation may include different weighted values for the result categories 22 and/or might include tunable weighted values depending on the relative importance assigned to the different types of failure.

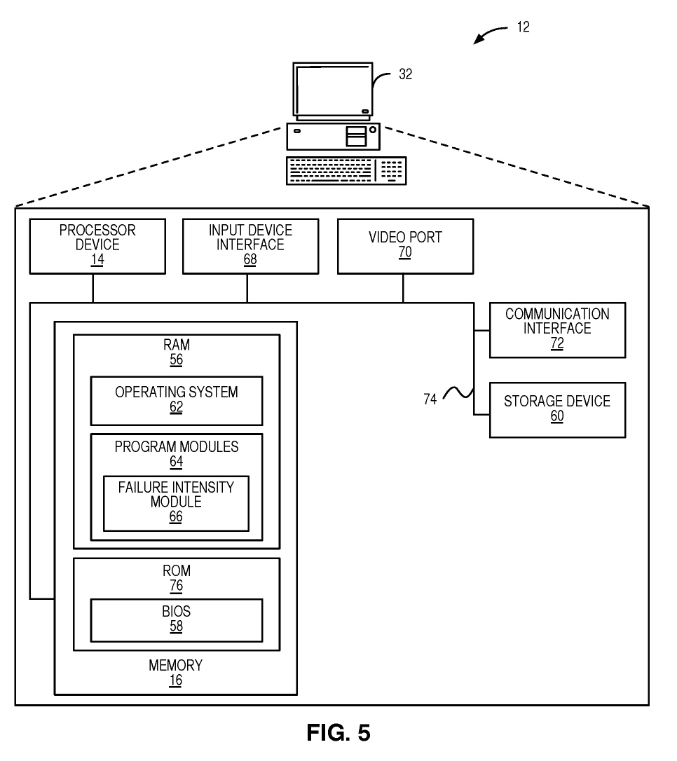

FIG. 5 is a block diagram of the computing device 12 suitable for implementing examples according to one example. The computing device 12 may comprise any computing or electronic device capable of including firmware, hardware, and/or executing software instructions to implement the functionality described herein, such as a computer server, a desktop computing device, a laptop computing device, a smartphone computing tablet, or the like. The computing device 12 includes the processor device 14, the system memory 16, and a system bus 74. The system bus 74 provides an interface for system components including, but not limited to, the system memory 16 and the processor device 14. The processor device 14 can be any commercially available or proprietary processor.

The system bus 74 may be any of several types of bus structures that may further interconnect to a memory bus (with or without a memory controller), a peripheral bus, and/or a local bus using any of a variety of commercially available bus architectures. The system memory 16 may include non-volatile memory 76 (e.g., read-only memory (ROM), erasable programmable read-only memory (EPROM), electrically erasable programmable read-only memory (EEPROM), etc.), and volatile memory 56 (e.g., random-access memory (RAM)). A basic input/output system (BIOS) 58 may be stored in the non-volatile memory 76 and can include the basic routines that help to transfer information between elements within the computing device 12. The volatile memory 56 may also include a high-speed RAM, such as static RAM, for caching data.

The computing device 12 may further include or be coupled to a non-transitory computer-readable storage medium such as a storage device 60, which may comprise, for example, an internal or external hard disk drive (HDD) (e.g., enhanced integrated drive electronics (EIDE) or serial advanced technology attachment (SATA)), HDD (e.g., EIDE or SATA) for storage, flash memory, or the like. The storage device 60 and other drives associated with computer-readable media and computer-usable media may provide non-volatile storage of data, data structures, computer-executable instructions, and the like. Although the description of computer-readable media above refers to an HDD, it should be appreciated that other types of media that are readable by a computer, such as Zip disks, magnetic cassettes, flash memory cards, cartridges, and the like, may also be used in the operating environment, and, further, that any such media may contain computer-executable instructions for performing novel methods of the disclosed examples.

A number of modules can be stored in the storage device 60 and in the volatile memory 56, including an operating system 62 and one or more program modules 64, such as the failure intensity module 66, which may implement the functionality described herein in whole or in part. It is to be appreciated that the examples can be implemented with various commercially available operating systems 62 or combinations of operating systems 62.

A number of modules can be stored in the storage device 60 and in the volatile memory 56, including, by way of non-limiting example, the failure intensity module 66. All or a portion of the examples may be implemented as a computer program product stored on a transitory or non-transitory computer-usable or computer-readable storage medium, such as the storage device 60, which includes complex programming instructions, such as complex computer-readable program code, to cause the processor device 14 to carry out the steps described herein. Thus, the computer-readable program code can comprise software instructions for implementing the functionality of the examples described herein when executed on the processor device 14. The processor device 14, in conjunction with the failure intensity module 66 in the volatile memory 56, may serve as a controller, or control system, for the computing device 12 that is to implement the functionality described herein.

An operator may also be able to enter one or more configuration commands through a keyboard (not illustrated), a pointing device such as a mouse (not illustrated), or a touch-sensitive surface such as the display device 32. Such input devices may be connected to the processor device 14 through an input device interface 68 that is coupled to the system bus 74 but can be connected by other interfaces such as a parallel port, an Institute of Electrical and Electronic Engineers (IEEE) 1394 serial port, a Universal Serial Bus (USB) port, an infrared (IR) interface, and the like.

The computing device 12 may also include a communications interface 72 suitable for communicating with the network as appropriate or desired. The computing device 12 may also include a video port 70 configured to interface with the display device 32, to provide information to the user.

Individuals will recognize improvements and modifications to the preferred examples of the disclosure. All such improvements and modifications are considered within the scope of the concepts disclosed herein and the claims that follow.

What is claimed is:

1. A computing device, comprising:
a memory; and
a processor device coupled to the memory to:
obtain a plurality of search sessions, where each search session of the plurality of search sessions comprises user input that identifies a search query;
classify each search session of the plurality of search sessions into one or more result categories, where each result category is indicative of an outcome of a search session; and
calculate a failure intensity value for the plurality of search sessions based on a combination of weighted values of the plurality of search sessions, where the weighted values are based on the one or more result categories of the plurality of search sessions.

2. The computing device of claim 1, wherein the processor device is further to produce a report comprising an indication of the failure intensity value for the plurality of search sessions.

3. The computing device of claim 2, wherein to produce the report, the processor device is to produce the report further comprising an indication of one or more of the weighted values of the plurality of search sessions on which the failure intensity value for the plurality of search sessions is based.

4. The computing device of claim 1, wherein:
to classify each search session of the plurality of search sessions into the one or more result categories, where each result category is indicative of the outcome of the search session, the processor device is further to classify at least one search session of the plurality of search sessions as a conversion result in response to a search query in the search session returning a selected result; and
to calculate the failure intensity value for the plurality of search sessions based on the combination of weighted values of the plurality of search sessions, where the weighted values are based on the one or more result categories of the plurality of search sessions, the processor device is further to use a weighted value of zero for the conversion result.

5. The computing device of claim 1, wherein:
to classify each search session of the plurality of search sessions into the one or more result categories, where each result category is indicative of the outcome of the search session, the processor device is further to classify at least one search session of the plurality of search sessions as a refinement result where the search session includes more than one search query; and
to calculate the failure intensity value for the plurality of search sessions based on the combination of weighted values of the plurality of search sessions, where the weighted values are based on the one or more result categories of the plurality of search sessions, the processor device is further to use a weighting factor which is a result of a nondecreasing function of a number of search queries included in the search session for the refinement result.

6. The computing device of claim 1, wherein:
to classify each search session of the plurality of search sessions into the one or more result categories, where each result category is indicative of the outcome of the search session, the processor device is further to classify at least one search session of the plurality of search sessions as an abandonment result where a user does not select any result returned from the search session; and
to calculate the failure intensity value for the plurality of search sessions based on the combination of weighted values of the plurality of search sessions, where the weighted values are based on the one or more result categories of the plurality of search sessions, the processor device is further to use a weighted value of an abandonment penalty value for the abandonment result.

7. The computing device of claim 6, wherein the processor device is further to determine the abandonment penalty value based on at least one of the group consisting of a user input and a stored system value.

8. The computing device of claim 6, wherein the abandonment penalty value is one half.

9. The computing device of claim 1, wherein:
to classify each search session of the plurality of search sessions into the one or more result categories, where each result category is indicative of the outcome of the search session, the processor device is further to classify at least one search session of the plurality of search sessions as one resulting in an initiation of a support case where the support case is initiated (but possibly not opened) for the search session; and
to calculate the failure intensity value for the plurality of search sessions based on the combination of weighted values of the plurality of search sessions, where the weighted values are based on the one or more result categories of the plurality of search sessions, the processor device is further to use a weighted value of a case creation penalty value for a case initiation result.

10. The computing device of claim 9, wherein:
to classify each search session of the plurality of search sessions into the one or more result categories, where each result category is indicative of the outcome of the search session, the processor device is further to classify at least one search session of the plurality of search sessions as a deflection result where a solution is found for the support case created for the search session; and
to calculate the failure intensity value for the plurality of search sessions based on the combination of weighted values of the plurality of search sessions, where the weighted values are based on the one or more result categories of the plurality of search sessions, the processor device is further to use a weighted value of zero for the deflection result.

11. The computing device of claim 9, wherein:
to classify each search session of the plurality of search sessions into the one or more result categories, where each result category is indicative of the outcome of the search session, the processor device is further to classify at least one search session of the plurality of search sessions as either a resolved result where a solution found for the support case created for the search session is new or a previously resolved result where the solution found for the support case created for the search session is not new; and
to calculate the failure intensity value for the plurality of search sessions based on the combination of weighted values of the plurality of search sessions, where the weighted values are based on the one or more result categories of the plurality of search sessions, the processor device is further to use a weighted value of zero for the resolved result and to use a weighted value of a previously resolved penalty value in case of a previously resolved result.

12. A computer program product for calculating a failure intensity value for a plurality of search sessions, the computer program product stored on a non-transitory computer-readable storage medium and including instructions configured to cause a processor device to:
obtain the plurality of search sessions, where each search session of the plurality of search sessions comprises user input that identifies a search query;
classify each search session of the plurality of search sessions into one or more result categories, where each result category is indicative of an outcome of a search session; and
calculate the failure intensity value for the plurality of search sessions based on a combination of weighted values of the plurality of search sessions, where the weighted values are based on the one or more result categories of the plurality of search sessions.

13. The computer program product of claim 12, including instructions to cause the processor device further to produce a report comprising an indication of the failure intensity value for the plurality of search sessions.

14. The computer program product of claim 13, wherein the instructions to cause the processor device to produce the report which comprises instructions to cause the processor device to produce the report further comprising an indication of one or more of the weighted values of the plurality of search sessions on which the failure intensity value for the plurality of search sessions is based.

15. The computer program product of claim 12, wherein:
the instructions to cause the processor device to classify each search session of the plurality of search sessions into the one or more result categories, where each result category is indicative of the outcome of the search session, comprise instructions to cause the processor device to classify a search session of the plurality of search sessions as a conversion result where a search query in the search session returns a selected result; and
the instructions to cause the processor device to calculate the failure intensity value for the plurality of search sessions based on the combination of weighted values of the plurality of search sessions, where the weighted values are based on the one or more result categories of the plurality of search sessions, comprise instructions to cause the processor device to use a weighted value of zero for the conversion result.

16. The computer program product of claim 12, wherein:
the instructions to cause the processor device to classify each search session of the plurality of search sessions into the one or more result categories, where each result category is indicative of the outcome of the search session, comprise instructions to cause the processor device to classify a search session of the plurality of search sessions as a refinement result where the search session includes more than one search query; and
the instructions to cause the processor device to calculate the failure intensity value for the plurality of search sessions based on the combination of weighted values of the plurality of search sessions, where the weighted values are based on the one or more result categories of the plurality of search sessions, comprise instructions to cause the processor device to use a weighted value of a nondecreasing function of a number of search queries included in the search session for the refinement result.

17. A method for calculating a failure intensity value for a plurality of search sessions, comprising:
obtaining, by a computing device comprising a processor device, the plurality of search sessions, where each search session of the plurality of search sessions comprises user input that identifies a search query;
classifying each search session of the plurality of search sessions into one or more result categories, where each result category is indicative of an outcome of a search session; and
calculating the failure intensity value for the plurality of search sessions based on a combination of weighted values of the plurality of search sessions, where the weighted values are based on the one or more result categories of the plurality of search sessions.

18. The method of claim 17, further comprising presenting, on a display device, an indication of the failure intensity value for the plurality of search sessions.

19. The method of claim 18, wherein presenting the indication of the failure intensity value further comprises presenting, on the display device, an indication of one or more of the weighted values of the plurality of search sessions on which the failure intensity value for the plurality of search sessions is based.

20. The method of claim 17, wherein:
classifying each search session of the plurality of search sessions into the one or more result categories, where each result category is indicative of an outcome of a search session, comprises classifying a search session of the plurality of search sessions as a conversion result in response to a search query in the search session returning a selected result; and
calculating the failure intensity value for the plurality of search sessions based on a combination of weighted values of the plurality of search sessions, where the weighted values are based on the one or more result categories of the plurality of search sessions comprises using a weighted value of zero for the conversion result.
